(19) United States
(12) Patent Application Publication
(10) Pub. No.: US 2026/0103240 A1
(43) Pub. Date: Apr. 16, 2026

(54) ENERGY ABSORBING DEVICE AND ROCKER ASSEMBLY HAVING AN ENERGY ABSORBING DEVICE

(71) Applicant: GM Global Technology Operations LLC, Detroit, MI (US)

(72) Inventors: Bradley Allen Newcomb, Troy, MI (US); Venkateshwar R. Aitharaju, Troy, MI (US); Bhavesh Shah, Troy, MI (US); Selina Xinyue Zhao, Rochester Hills, MI (US); Patrick H. Clark, Royal Oak, MI (US); Vincent R. Gonzales, Warren, MI (US); Edward D. Moss, Commerce Twp., MI (US); Nick Colonna, Vaughan (CA)

(73) Assignee: GM Global Technology Operations LLC, Detroit, MI (US)

(21) Appl. No.: 18/912,337

(22) Filed: Oct. 10, 2024

(51) Int. Cl. B62D 21/15; B32B 3/04; B32B 3/28; B32B 5/02; B32B 15/14; B62D 25/02; B62D 29/00

(52) U.S. Cl. CPC B62D 21/157; B32B 3/04; B32B 3/28; B32B 5/02; B32B 15/14; B62D 25/025; B62D 29/001; B32B 2260/021; B32B 2260/046; B32B 2307/56; B32B 2307/7376; B32B 2605/00

(57) ABSTRACT

An energy absorbing device and rocker assembly for use in a vehicle is provided. In one aspect, the energy absorbing device includes a sheet formed of a composite material. The sheet includes a width extending along a width of the vehicle and a length extending along a length of the vehicle. The sheet has a sinusoidal form formed along the length of the sheet. The rocker assembly includes an inner rocker and an outer rocker coupled together so as to enclose an interior space. A carrier is disposed within the interior space, wherein the carrier is configured to hold the energy absorbing device disposed within the interior space.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to energy absorbing devices and rocker assemblies for vehicles, and more particularly to energy absorbing devices and rocker assemblies configured to be tuned to specific load demands using composite materials with sinusoidal forms.

Vehicles, such as automobiles, trucks, buses, and the like, are designed to protect occupants and vehicle components from damage or injury in the event of a collision or impact. One of the ways to achieve this protection is to provide energy absorbing devices and structures that can deform or crush under a load and dissipate the kinetic energy of the impact. For example, vehicles may have bumpers, crumple zones, side rails, and other components that act as energy absorbers.

In particular, vehicles may include a rocker assembly which is attached along the floor of the vehicle and extends from the front of the vehicle to the rear of the vehicle. The rocker assembly includes an inner rocker and an outer rocker and is formed of a metal material. Under such a configuration, the rocker assembly is configured to absorb energy from a front or rear impact with greater efficiency relative to a side impact. Further, metal structures may have limitations in terms of weight, cost, performance, and design flexibility. For example, metal-based energy absorbers may be heavy, expensive, prone to corrosion, and difficult to shape or modify. Moreover, metal-based energy absorbers may have a limited range of deformation and energy absorption capacity.

Accordingly, it remains desirable to provide an energy absorbing device and rocker assemblies for vehicles that may be tunable and configured to provide different load absorption characteristics at different areas.

### SUMMARY

In one configuration, an energy absorbing device for use in a vehicle includes a sheet formed of a composite material. The sheet has a width extending along a width of the vehicle and a length extending along a length of the vehicle, wherein the sheet has a sinusoidal form formed along the length of the sheet.

The energy absorbing device may include one or more of the following optional features. For example, a thickness of the sheet of material varies along the length of the sheet. In yet another aspect, the sheet includes a plurality of arcuate sections along the sinusoidal form, wherein a number of arcuate sections in a load portion is greater than a number of arcuate sections in a non-load portion, thereby enhancing the energy absorption efficiency and reducing the weight of the sheet.

In one configuration, the sheet is a first sheet of material and a second sheet of material, wherein the first sheet of material is joined to the second sheet of material to form a plurality of tubes interconnected to each other by a neck portion.

In one configuration, the composite material is one selected from the group consisting of: carbon fiber reinforced polymer, glass fiber reinforced polymer, aramid fiber reinforced polymer, and natural fiber reinforced polymer.

In one configuration, a rocker assembly for use in a vehicle is provided. The rocker assembly includes an inner rocker and an outer rocker coupled together so as to enclose an interior space. The inner rocker and the outer rocker extend along a length of the vehicle. The rocker assembly further includes a carrier and an energy absorbing device. The carrier is disposed within the interior space and is configured to hold the energy absorbing device. The energy absorbing device is a sheet formed of a composite material. The sheet has a length extending along a length of the inner rocker and a width extending between the inner rocker and the outer rocker, wherein the sheet has a sinusoidal form extending along the length of the sheet.

The rocker assembly may include one or more of the following optional features. For example, the inner rocker and the outer rocker may be made of a metal, such as steel, aluminum, or any alloy thereof. In another aspect, the carrier includes a first flange configured to be attached between the inner rocker and outer rocker, and a fastening member for attachment to one of the inner rocker or the outer rocker, thereby securing the carrier and the energy absorbing device within the interior space.

In one configuration of the rocker assembly, a thickness of the sheet of material varies.

In one configuration, the sheet includes a plurality of arcuate sections along the sinusoidal form and a number of arcuate sections in a load portion is greater than a number of arcuate sections in a non-load portion.

In one configuration, the sheet includes a plurality of tubes interconnected to each other by a neck portion.

In one configuration of the rocker assembly, the composite material is one selected from the group consisting of: carbon fiber reinforced polymer, glass fiber reinforced polymer, aramid fiber reinforced polymer, and natural fiber reinforced polymer.

In one configuration of the rocker assembly, the carrier includes a planar surface extending along the length of the sheet and interposed between the sheet and at least one of the inner rocker and the outer rocker.

In yet another configuration, a vehicle is provided. The vehicle includes a chassis extending along a length of the vehicle between a front of the vehicle and a rear of the vehicle, and a plurality of cross bars extending along a width of the vehicle. The vehicle includes a rocker assembly disposed on the chassis and extending along the length of the vehicle. The rocker assembly includes an inner rocker, an outer rocker, a carrier and an energy absorbing device. The inner rocker and the outer rocker are coupled together so as to enclose an interior space, wherein the carrier is disposed within the interior space and is configured to hold the energy absorbing device disposed within the interior space. The energy absorbing device is a sheet formed of a composite material. The sheet has a length extending along a length of the inner rocker and a width extending between the inner rocker and the outer rocker, wherein the sheet has a sinusoidal form extending along the length of the sheet.

The vehicle may include one or more of the following optional features. For example, the inner rocker and the outer rocker may be made of a metal, such as steel, aluminum, or any alloy thereof. In another aspect, a thickness of the sheet of material varies. In yet another aspect, the carrier includes a planar surface extending along the length of the sheet and interposed between the sheet and at least one of the inner rocker and the outer rocker.

In one configuration, the sheet includes a plurality of arcuate sections along the sinusoidal form and a number of arcuate sections in a load portion is greater than a number of arcuate sections in a non-load portion.

In one configuration, the sheet is a first sheet of material and a second sheet of material, wherein the first sheet of material is joined to the second sheet of material to form a plurality of tubes interconnected to each other by a neck portion.

### BRIEF DESCRIPTION OF THE DRAWINGS

The drawings described herein are for illustrative purposes only of selected configurations and are not intended to limit the scope of the present disclosure.

FIG. 1 is a perspective view of a vehicle including an energy absorbing device according to the present disclosure;

FIG. 2 is a cross-sectional view of the energy absorbing device of the vehicle shown in FIG. 1 taken along line 2-2.

FIG. 3 is a cross-sectional view of the energy absorbing device of the vehicle shown in FIG. 1 taken along line 3-3.

FIG. 4 is an assembled view of the rocker assembly according to the present disclosure;

FIG. 5 is a perspective exploded view of a rocker assembly shown in FIG. 4.

FIG. 6 is a perspective exploded view showing the carrier and the energy absorbing device shown in FIG. 4.

FIG. 7 is a perspective exploded view of the rocker assembly according to another aspect of the present disclosure.

FIG. 8 is a perspective exploded view of the energy absorbing device shown in FIG. 7.

FIG. 9 is a plan view of an energy absorbing device taken from the side.

FIG. 10 is an exploded view of the energy absorbing device according to another aspect of the present disclosure.

FIG. 11 is an exploded view of the energy absorbing device according to another aspect of the present disclosure.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

An energy absorbing device includes a sheet formed of a composite material, wherein the sheet has a width extending along a width of the vehicle and a length extending along a length of the vehicle, wherein the sheet has a sinusoidal form formed along the length of the sheet so as to absorb energy from a side impact. The sheet may be tunable so as to provide different energy absorbing characteristics at different locations along the length of the sheet. Accordingly, the energy absorbing device may be configured to provide different levels of stiffness and energy absorption capacity to account for vehicle structure.

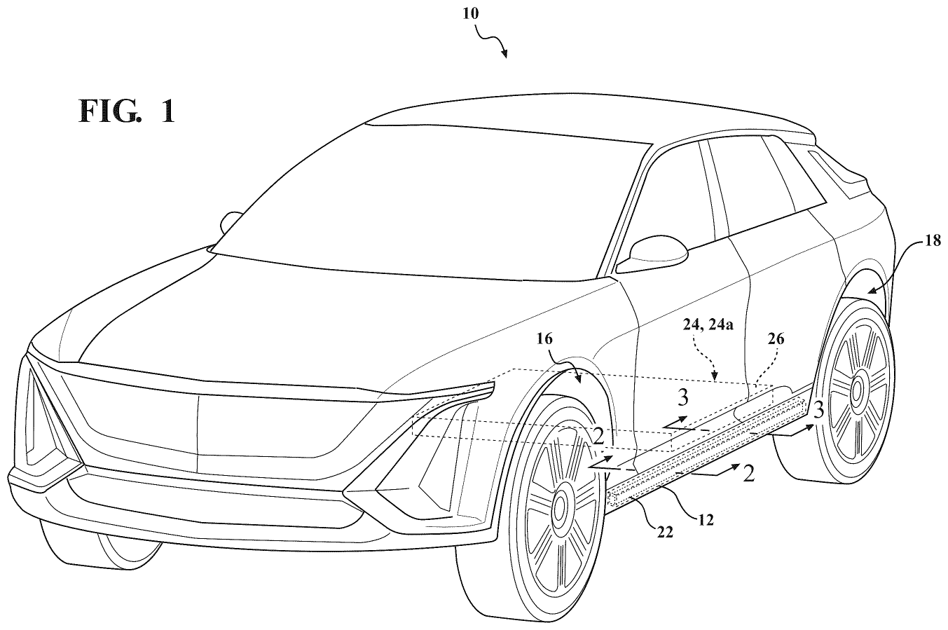

With reference to FIG. 1 a vehicle 10 is provided. The vehicle 10 includes an energy absorbing device 12 that extends along a length of the vehicle 10. For exemplary purposes, the energy absorbing device 12 is shown mounted to a chassis 14 of the vehicle 10. In particular, the energy absorbing device 12 is shown mounted to the chassis 14 and extends between a front wheel well 16 and a rear wheel well 18. For illustrative purposes, the energy absorbing device 12 is shown disposed on a driver side of the vehicle 10. However, it should be appreciated that the energy absorbing device 12 may be disposed in other locations of the vehicle 10 to provide impact absorbing functions. For instance, the vehicle 12 may include another energy absorbing device 12 extending between a front wheel well 16 and a rear wheel well 18 disposed on a front passenger side of the vehicle 10 as well, or along the front or rear bumper.

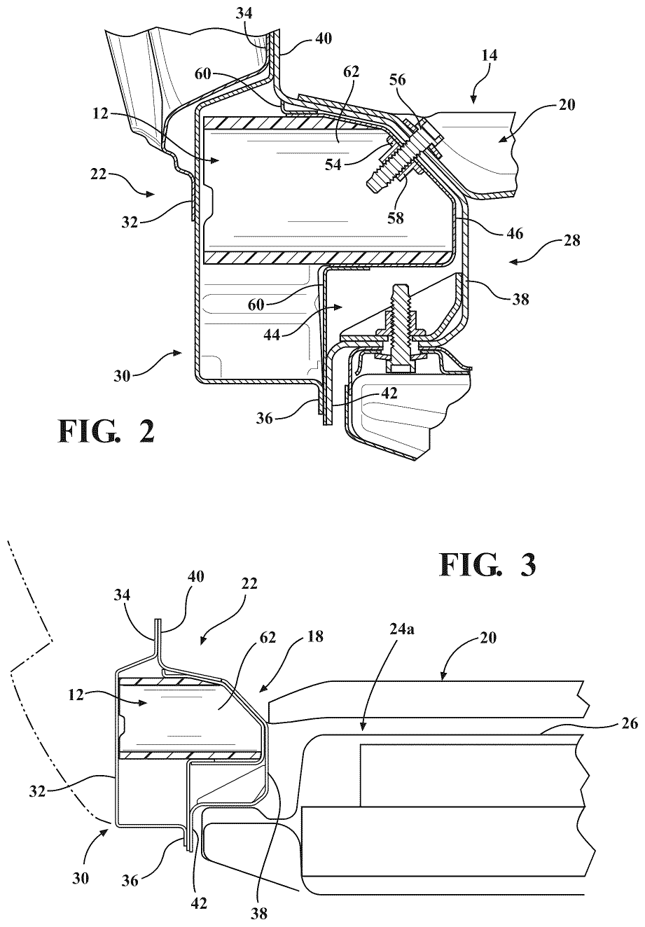

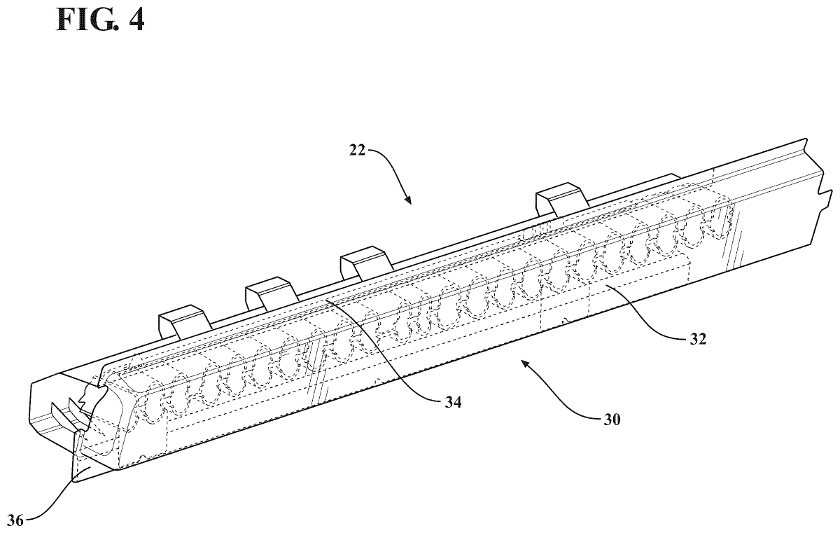

With reference now to FIGS. 2 and 3, cross-sectional views of the energy absorbing device 12 taken along lines 2-2 and 3-3 of FIG. 1 are provided. The chassis 14 is formed of a durable rigid material such as steel and may include a plurality of cross-bars 20 and a pair of rocker assemblies 22. The rocker assemblies 22 are spaced apart from and generally parallel to each other and extend along the length of the vehicle 10. Each end of the cross-bars 20 is joined to the pair of rocker assemblies 22 so as to extend across a width of the vehicle 10.

The chassis 14 may be configured to support various vehicle components 24, such as battery assembly 24a. The battery assembly 24a may include a housing 26 for accommodating a battery (not shown) and various electric components such as wiring, fuses, relays and the like (not shown). In one aspect, the cross-bar 20 may be disposed above the battery assembly 24a and the battery assembly 24a may be attached to the cross-bar 20 using known attachment techniques such as bolts, screws, brackets, and the like.

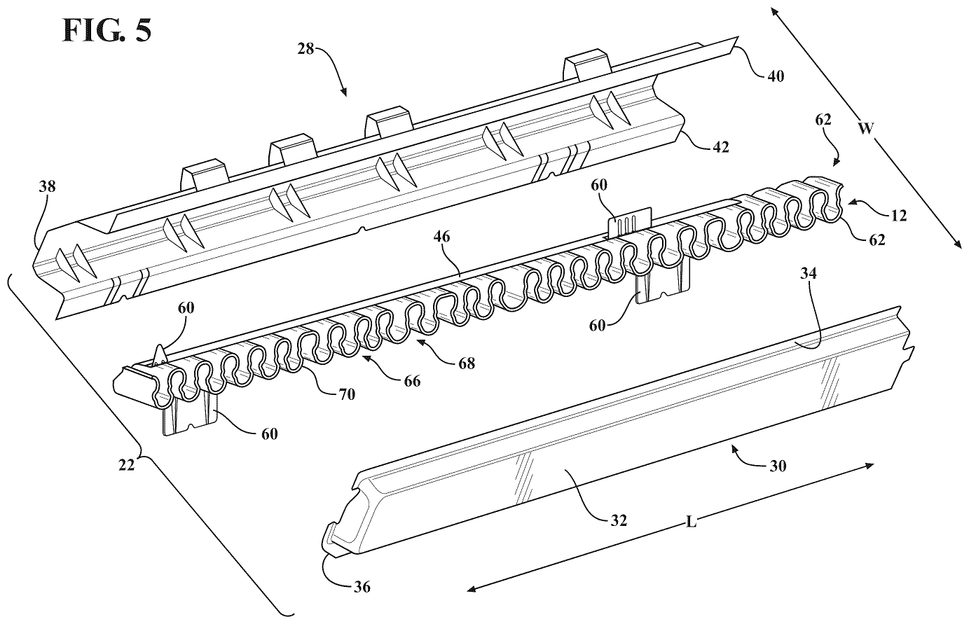

With reference again to FIGS. 2 and 3 and now to FIG. 5, a description of the rocker assembly 22 is provided. The rocker assembly 22 includes an inner rocker 28 and an outer rocker 30, which are coupled together and configured to hold the energy absorbing device 12. When the rocker assembly 22 is assembled, the outer rocker 30 is disposed exterior of the inner rocker 28. The outer rocker 30 includes an outer mid-portion 32, an outer upper flange 34, and an outer lower flange 36. The outer upper flange 34 and the outer lower flange 36 are disposed on opposite ends of the outer mid-portion 32. The outer mid-portion 32 has a generally U-shaped cross-section.

The inner rocker 28 includes an inner mid-portion 38, an inner upper flange 40, and an inner lower flange 42. The inner upper flange 40 and the inner lower flange 42 are disposed on opposite ends of the inner mid-portion 38. The inner mid-portion 38 has a generally U-shaped cross-section when taken along its width. The outer upper flange 34 and the inner upper flange 40 are attached to each other and the outer lower flange 36 and the inner lower flange 42 are attached to each other, wherein the inner mid-portion 38 and the outer mid-portion 32 are spaced apart from each other to form an interior space 44 for accommodating the energy absorbing device 12. It should be appreciated that the outer upper flange 34, the inner upper flange 40, the outer lower flange 36, and the inner lower flange 42 may be attached to each other using known attachment techniques, to include welding, mechanical fasteners, adhesives and the like.

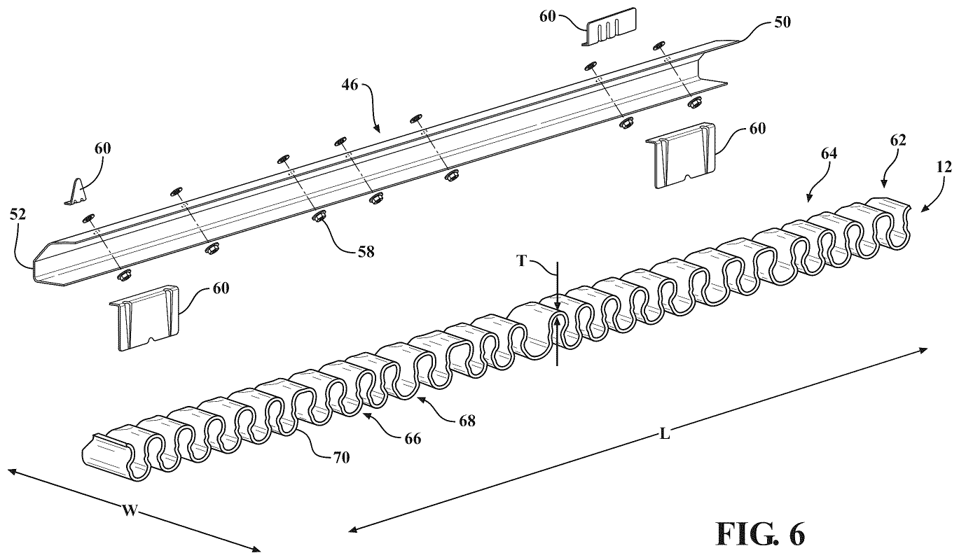

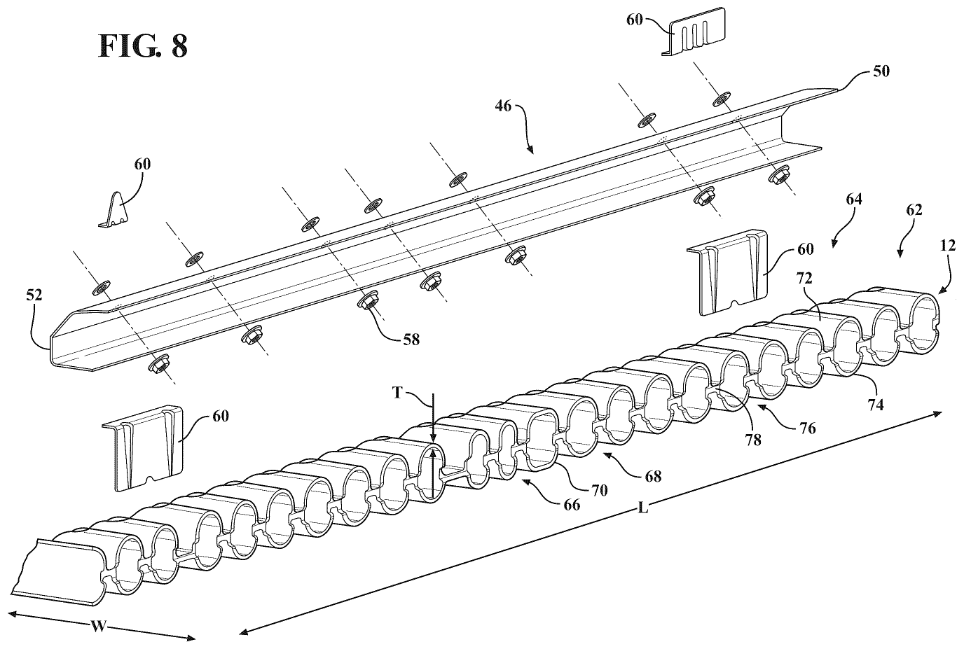

With reference now to FIGS. 6 and 8, the rocker assembly 22 may further include a carrier 46. The carrier 46 is also formed of a rigid and durable material, such as steel, and is configured to hold the energy absorbing device 12 within the interior space 44. The carrier 46 is an elongated member having a generally U-shaped cross-section configured to support the energy absorbing device 12. In particular, the carrier 46 includes a bottom seat 48, a ceiling portion 50 spaced apart from the bottom seat 48, and a back wall 52 interconnecting the bottom seat 48 to the ceiling portion 50. The bottom seat 48 and the ceiling portion 50 are generally planar surfaces extending the length of the carrier 46. The bottom seat 48 and the ceiling portion 50 are spaced apart from each other so as to fittingly receive the energy absorbing device 12, wherein a bottom portion of the energy absorbing device 12 rests upon the bottom seat 48 of the carrier 46. As such, the carrier 46 holds the energy absorbing device 12 within the interior space 44 of the rocker assembly 22.

The carrier 46 includes attachment structures for attachment to the rocker assembly 22. For instance, the carrier 46 may include a plurality of through-holes 54 for receiving a bolt 56, wherein the bolt 56 is passed through one of the inner rocker 28 or the outer rocker 30 so as to secure the carrier 46 thereto. FIG. 2 shows an aspect where the bolt 56 is passed through the outer rocker 30 and a nut 58 is disposed within the interior space 44. The bolt 56 is screwed into the nut 58 so as to secure the carrier 46 to the outer rocker 30. In one aspect, the sheet 12 is free of any holes and is supported within the rocker assembly 22 solely by the carrier 46. Thus, the integrity of the sheet 12 is not compromised as the sheet 12 is smooth and continuous. The carrier 46 is not configured to provide energy absorbing functions but is configured to hold the energy absorbing device 12 within the interior space 44.

In another aspect of an attachment structure, the carrier 46 may include one or more flanges 60 which may be fixed to the carrier 46 using any known or later developed attachment techniques, to include welding, fasteners, and adhesive or the like. As shown in FIGS. 2 and 3, the flanges 60 are sandwiched between a corresponding outer upper flange 34, inner upper flange 40, outer lower flange 36, and the inner lower flange 42. Accordingly, the carrier 46 holds the energy absorbing device 12 within the interior space 44 of the rocker assembly 22.

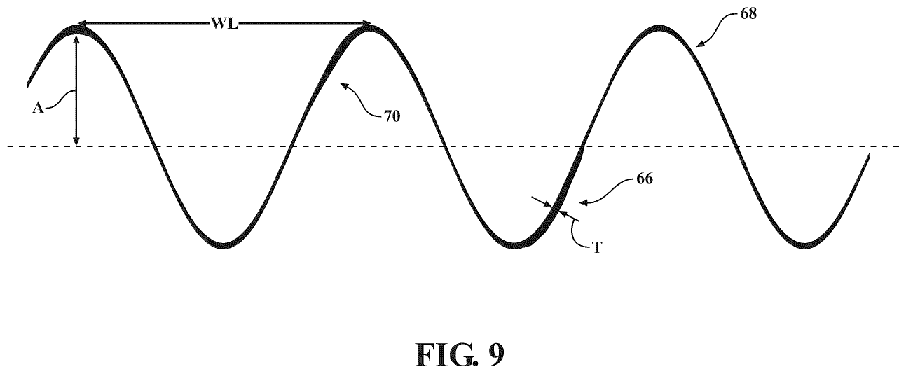

With reference now to FIGS. 5, 6 and 9, a depiction of the energy absorbing device 12 is provided. The energy absorbing device 12 is a sheet 62 formed of a composite material. The energy absorbing device 12 has a length “L” which runs along the length of the vehicle 10 and a width “W” which runs along the width of the vehicle 10. FIGS. 5 and 6 depict an aspect where the sheet 62 has a thickness “T” which is generally uniform. The sheet 62 has a generally sinusoidal form 64 formed along the length L of the sheet 62. That is, the sheet 62 forms a plurality of waves that are contiguous with each other along the length “L” of the sheet 62. The sinusoidal form 64 may be regular in that each wave may have the same wave length “WL” and the same amplitude “A,” as indicated in FIG. 9. FIGS. 5 and 6 depict an aspect where the sinusoidal form 64 is irregular in that the wavelength “WL” and the amplitude “A” of each wave varies along the length of the sheet 62.

The composite material of the sheet 62 may be a material selected from the group comprising: carbon fiber reinforced polymer (CFRP), glass fiber reinforced polymer (GFRP), aramid fiber reinforced polymer (AFRP), and natural fiber reinforced polymer (NFRP). The material may be set or otherwise bound by thermoset polymers, thermoplastic polymers or any combination thereof. The composite material may have a high strength-to-weight ratio, a high stiffness-to-weight ratio, a high fatigue resistance, a high corrosion resistance, and a high thermal stability. The composite material may also have a low density, a low cost, and a high recyclability. The composite material may be formed by impregnating fibers with a resin matrix, such as epoxy, polyester, vinyl ester, or any other suitable resin. The fibers may be arranged in various orientations, such as unidirectional, bidirectional, multidirectional, woven, non-woven, or any combination thereof. The sheet 62 may be formed by molding, curing, cutting, pultruding or any other suitable process.

The thermoset polymers are independently selected from the group consisting of: benzoxazine, a bis-maleimide (BMI), a cyanate ester, an epoxy, a phenolic (PF), a polyacrylate (acrylic), a polyimide (PI), an unsaturated polyester, a polyeurethane (PUR), a vinyl ester, a siloxane, co-polymers thereof, and combinations thereof.

The thermoplastic polymers are independently selected from the group consisting of: polyethylenimine (PEI), polyamide-imide (PAI), polyamide (PA) (e.g., nylon 6, nylon 66, nylon 12), polyetheretherketone (PEEK), polyetherketone (PEK), a polyphenylene sulfide (PPS), a thermoplastic polyurethane (TPU), polypropylene (PP), polycarbonate/acrylonitrile butadiene styrene (PC/ABS), high-density polyethylene (HDPE), polyethylene terephthalate (PET), poly(methyl methacrylate) (PMMA), polycarbonate (PC), polyaryletherketone (PAEK), polyetherketoneketone (PEKK), co-polymers thereof, and combinations thereof.

With reference again to FIG. 9, a plan view taken along a side of the energy absorbing device 12 is provided. FIG. 9 shows an aspect where the wavelength “WL” and the amplitude “A” of each wave is generally the same, and consequently each of the waves forming the sinusoidal form 64 has the same number of arcuate sections as each other. However, a thickness “T” of the sheet 62 varies along the length L of the sheet 62. For example, the thickness “T” may be greater in a load portion 66 of the sheet 62 than in a non-load portion 68 of the sheet 62. For instance, the thickness “T” may be greater where the cross-bar 20 or battery assembly 24a is adjacent to the energy absorbing device 12 relative to areas of the energy absorbing device 12 where no vehicle component 24 or cross-bar 20 exists. The load portion 66 may be a portion of the sheet 62 that is positioned to receive a higher load or impact force than the non-load portion 68. For example, the load portion 66 may be located adjacent a cross-bar 20 as shown in FIG. 2 or a vehicle 10 component such as the battery assembly 24a as shown in FIG. 3. The non-load portion 68 may be a portion of the sheet 62 where the rocker assembly 22 is not directly connected to a vehicle structure and, thus, the impact and load absorbing characteristics are tuned for a lower load or impact force relative to the load portion 66. For example, the non-load portion 68 may be areas along the rocker assembly 22 devoid of a cross-bar 20 or a vehicle component 24. Thus, it should be appreciated that the term non-load does not mean that the corresponding area of the sheet 62 is not susceptible to impact. The entirety of the sheet 62 is configured to provide energy absorbing functions. FIG. 9 illustrates that the load portion 66 of the sheet 62 corresponds to areas where the sheet 62 is thicker and, thus, the non-load portion 68 corresponds to the thinner areas of the sheet 62. It should further be appreciated that the thickness “T” of the load portions 66 may vary so as to be tuned to a desired load absorbing characteristic.

By varying the thickness “T” of the sheet 62, the stiffness and the energy absorption capacity of the sheet 62 may be adjusted according to the expected load or impact force. For example, a thicker sheet 62 may have a higher stiffness and a higher energy absorption capacity than a thinner sheet 62. Therefore, the energy absorbing device 12 may provide a variable stiffness and energy absorption capacity along the length L of the sheet 62, thereby enhancing the performance and efficiency of the energy absorbing device 12. Using FIGS. 2 and 3 as an example, the thickness “T” of the sheet 62 may be greater where both a cross-bar 20 and a vehicle component 24 contact the rocker assembly 22 as shown in FIG. 3, relative to the thickness “T” of the sheet where only a cross-bar 20 is in contact with the rocker assembly 22. Further, a thickness “T” of the sheet 62 where the rocker assembly 22 is free of a cross-bar 20 may be thinner than the thickness “T” of the sheet 62 where the rocker assembly 22 is in contact with the cross-bar 20.

Referring again to FIGS. 5-7, the sheet 62 may include a plurality of arcuate sections 70 contiguous with each other and along the sinusoidal form 64. The arcuate sections 70 may have a curved or rounded shape so as to reduce or eliminate linear lengths of the sinusoidal form 64 extending between a crest and trough of the sinusoidal form 64. The arrangement of arcuate sections 70 is not limiting. For instance, the one wave of the sinusoidal form 64 may include three arcuate sections between the crest and the trough of the wave, while another wave of the sinusoidal form 64 may include six arcuate sections between the crest and the trough of the wave. Thus, it should be appreciated that the sinusoidal form 64 may be irregular. The arcuate sections 70 may be formed at locations of the sheet 62 adjacent or otherwise positioned to come into contact with a vehicle component 24 such as the battery assembly 24a.

The number of arcuate sections 70 may vary along the length “L” of the sheet 62. For example, the number of arcuate sections 70 may be greater in the load portion 66 of the sheet 62 than in the non-load portion 68 of the sheet 62. By varying the number of arcuate sections 70, the weight and the energy absorption capacity of the sheet 62 may be adjusted according to the expected load or impact force. For example, a higher number “N” of arcuate sections 70 may result in a lower weight and a higher energy absorption capacity of the sheet 62 than a lower number “N” of arcuate sections 70. Therefore, the energy absorbing device 12 may provide a variable weight and energy absorption capacity along the length “L” of the sheet 62, thereby enhancing the performance and efficiency of the energy absorbing device 12.

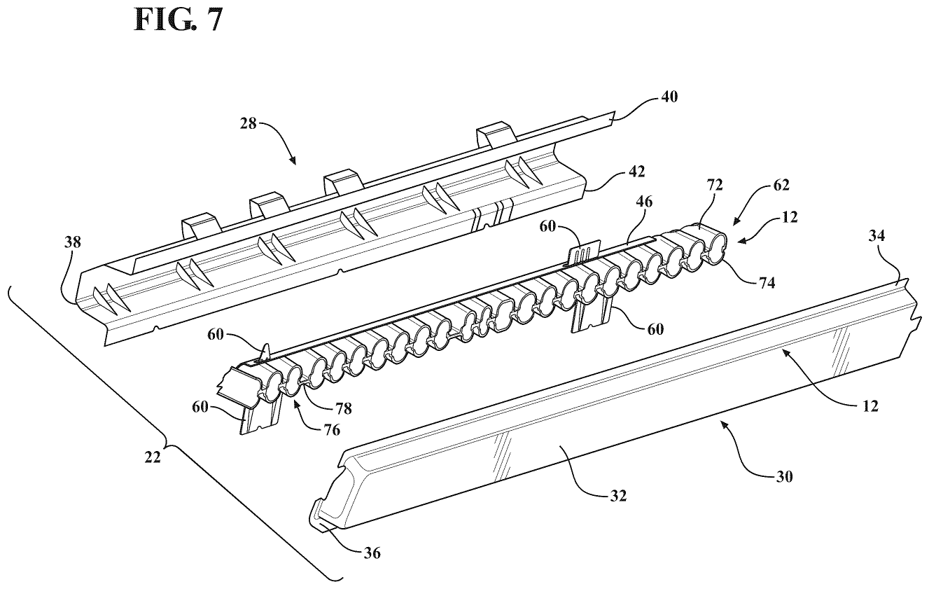

With reference again to FIG. 7 and now to FIG. 8, another aspect of the energy absorbing device 12 according to the principles described herein is provided. In one aspect, the sheet 62 may be formed of a first sheet of material 72 and a second sheet of material 74 that are coupled together to form a unitary structure. In one aspect, the first sheet of material 72 is formed of the same material as the second sheet of material 74. In another aspect, the first sheet of material 72 is formed of a material that is different than the second sheet of material 74. The first sheet of material 72 is joined to the second sheet of material 74 to form a plurality of tubes 76 interconnected to each other by a neck portion 78. FIGS. 7 and 8 depict an aspect where the sinusoidal form 64 of the first sheet of material 72 mirrors the sinusoidal form 64 of the second sheet of material 74, and the thickness of the first sheet of material 72 and the second sheet of material 74 are the same and is uniform along the length of the sheet 62. However, it should be appreciated that the first sheet of material 72 and the second sheet of material 74 may have different thicknesses “T,” widths, wavelengths, and amplitudes.

FIGS. 7 and 8 show an aspect where the first sheet of material 72 has the same number of arcuate sections 70 as the second sheet of material 74 and the arcuate sections 70 mirror each other. However, it should be appreciated that the first sheet of material 72 may contain a different number of arcuate sections 70 than the second sheet of material 74 and the arcuate sections 70 of the first sheet of material 72 are not aligned or otherwise mirror the second sheet of material 74 so as to form tubes 76 that have an irregular diameter. The tubes 76 may increase the strength and rigidity of the sheet 62, as well as the energy absorption capacity of the sheet 62. The neck portion 78 may provide a connection between the tubes 76, as well as a flexibility and a deformability of the sheet 62. It should further be appreciated that the first sheet of material 72 and the second sheet of material 74 may be formed from a singular sheet of material 62, in which case a reference made to a first sheet of material 72 and a second sheet of material 74 is done simply to point out portions of the tubes 76 and neck portion 78.

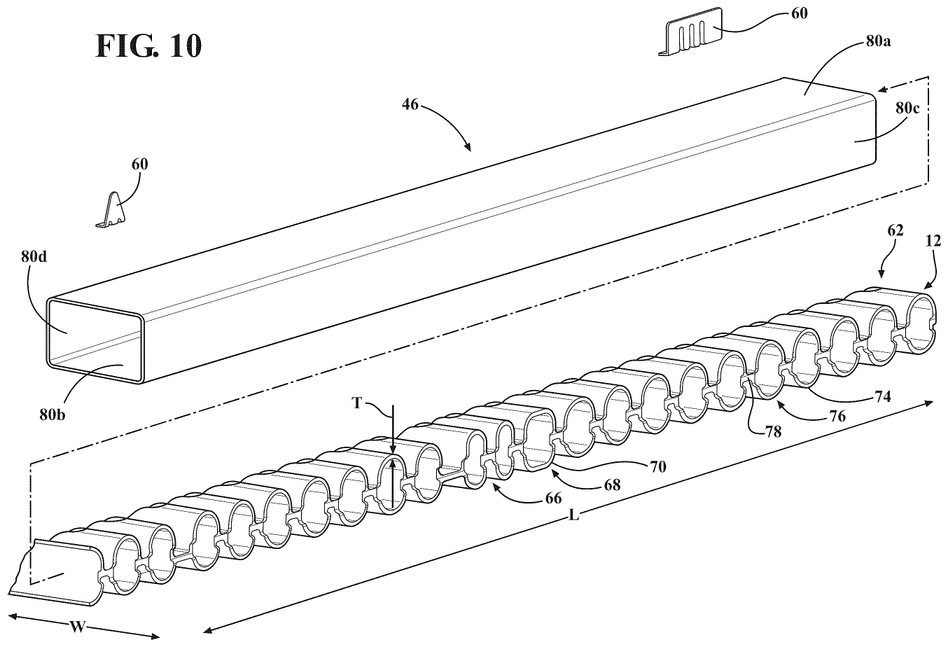

With reference now to FIG. 10, in another aspect of the disclosure, the carrier 46 includes a planar surface extending along the length of the sheet 62 and interposed between the sheet 62 and at least one of the inner rocker 28 and the outer rocker 30. In such an aspect, the carrier 46 includes a top wall 80a, a bottom wall 80b, a front wall 80c, and a back wall 80d that are connected to each other to form a rectangular tube having a through-hole configured to receive the sheet 62. The front wall 80c and the back wall 80d are planar surfaces and are configured to be pressed against each side of the sheet 62. Thus, during an impact, energy is translated along the wave form by the planar surface of the front wall 80c or the back wall 80d as the case may be. In such an aspect, the carrier 46 may be formed of a durable and rigid material such as steel. A length of the carrier 46 may be substantially the same as the length of the sheet 62 and a width of the carrier 46 is wider than the width of the sheet 62 but is dimensioned so as to place the sides of the sheet 62 into contact with the inner surface of the front wall 80c and the back wall 80d. Flanges 60 may be attached to the carrier 46 using known attachment techniques and/or mechanical fasteners such as welding, bolts, screws, adhesives and the like. As described above, the flanges 60 may be used to attach the carrier 46 within the interior space 44 of the rocker assembly 22.

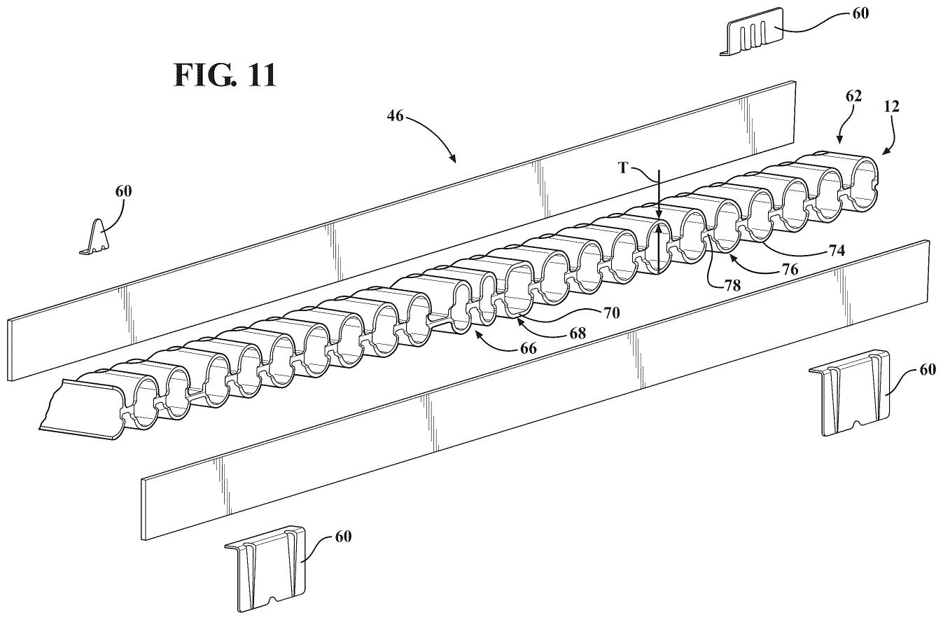

With reference now to FIG. 11, in another aspect of the disclosure, the carrier 46 is formed of a first sheet 82a and/or a second sheet 82b. The first sheet 82a and the second sheet 82b are planar and are configured to be pressed against each side of the sheet 62. Thus, during an impact, energy is translated along the wave form by the planar surface of the first sheet 82a and the second sheet 82b as the case may be. In such an aspect, the first sheet 82a and the second sheet 82b may be formed of a durable and rigid material such as steel. A length of the first sheet 82a and the second sheet 82b may be substantially the same as the length of the sheet 62. Flanges 60 may be attached to the first sheet 82a and the second sheet 82b using known attachment techniques and/or mechanical fasteners such as welding, bolts, screws, adhesives and the like. As described above, the flanges 60 may be used to attach the first sheet 82a and the second sheet 82b within the interior space 44 of the rocker assembly 22 so as to place the first sheet 82a and the second sheet 82b into contact with the sides of the sheet 62. For instance, flanges 60 may be used to secure the first sheet 82a between the sheet 62 and the inner rocker 28 and to secure the second sheet 82b between the sheet 62 and the outer rocker 30.

In operation, the energy absorbing device 12 is positioned to withstand a side impact, e.g., an impact along the width of the vehicle 10. As the width of the sheet 62 extends along the width of the vehicle 10, the sheet 62 is configured to receive the side impact and be pulverized, fragmented or otherwise crushed under a predetermined load. By adjusting the thickness of the sheet 62 or the number of arcuate sections 70 along the length of the sheet 62, the energy absorbing device 12 may be tuned to account for vehicle components 24. Thus, in areas of the vehicle 10 where a vehicle 10 component, such as a battery assembly 24a is located, the energy absorbing device 12 may be configured to protect the vehicle 10 component by increasing a thickness of the sheet 62 or including arcuate sections 70. It should be appreciated that the energy absorbing device 12 may provide better energy absorbing characteristics on a weight basis relative to energy absorbing structures made of metal by virtue of being formed of composite materials. Thus, not only does the energy absorbing device provide impact damping benefits but also improves the vehicle efficiency by reducing weight.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. An energy absorbing device for use in a vehicle, the energy absorbing device comprising:
a sheet formed of a composite material, the sheet having a width extending along a width of the vehicle and a length extending along a length of the vehicle, wherein the sheet has a sinusoidal form formed along the length of the sheet.

2. The energy absorbing device as set forth in claim 1, wherein a thickness of the sheet of material varies.

3. The energy absorbing device as set forth in claim 1, wherein the sinusoidal form is irregular.

4. The energy absorbing device as set forth in claim 3, wherein the sheet includes a plurality of arcuate sections along the sinusoidal form and a number of arcuate sections in a load portion is greater than the number of arcuate sections in a non-load portion.

5. The energy absorbing device as set forth in claim 1, wherein the sheet is a first sheet of material and a second sheet of material, the first sheet of material joined to the second sheet of material to form a plurality of tubes interconnected to each other by a neck portion.

6. The energy absorbing device as set forth in claim 1, wherein the composite material is one selected from the group consisting of: carbon fiber reinforced polymer, glass fiber reinforced polymer, aramid fiber reinforced polymer, and natural fiber reinforced polymer.

7. A rocker assembly for use in a vehicle, the rocker assembly comprising:
an inner rocker and an outer rocker coupled together so as to enclose an interior space, the inner rocker and the outer rocker extending along a length of the vehicle;
a carrier disposed within the interior space; and
an energy absorbing device disposed within the interior space and held by the carrier, wherein energy absorbing device is a sheet formed of a composite material, the sheet having a length extending along the length of the inner rocker and a width extending between the inner rocker and the outer rocker, wherein the sheet has a sinusoidal form extending along the length of the sheet.

8. The rocker assembly as set forth in claim 7, wherein the inner rocker and the outer rocker are made of a metal.

9. The rocker assembly as set forth in claim 7, wherein the carrier includes a first flange configured to be attached between the inner rocker and the outer rocker.

10. The rocker assembly as set forth in claim 7, wherein the carrier includes a fastening member for attachment to one of the inner rocker or the outer rocker.

11. The rocker assembly as set forth in claim 7, wherein a thickness of the sheet of material varies.

12. The rocker assembly as set forth in claim 7, wherein the sheet includes a plurality of arcuate sections along the sinusoidal form and a number of arcuate sections in a load portion is greater than the number of arcuate sections in a non-load portion.

13. The rocker assembly as set forth in claim 7, wherein the sheet includes a plurality of tubes interconnected to each other by a neck portion.

14. The rocker assembly as set forth in claim 7, wherein the composite material is one selected from the group consisting of: carbon fiber reinforced polymer, glass fiber reinforced polymer, aramid fiber reinforced polymer, and natural fiber reinforced polymer.

15. The rocker assembly as set forth in claim 7, wherein the carrier includes a planar surface extending along the length of the sheet and interposed between the sheet and at least one of the inner rocker and the outer rocker.

16. A vehicle including a chassis extending along a length of the vehicle between a front of the vehicle and a rear of the vehicle, and a plurality of cross bars extending along a width of the vehicle, the vehicle comprising:
a rocker assembly disposed on the chassis and extending along the length of the vehicle, the rocker assembly including an inner rocker, an outer rocker, and a carrier, the inner rocker and the outer rocker coupled together so as to enclose an interior space, wherein the carrier is disposed within the interior space; and
an energy absorbing device disposed within the interior space and held by the carrier, wherein energy absorbing device is a sheet formed of a composite material, the sheet having a length extending along a length of the inner rocker and a width extending between the inner rocker and the outer rocker, wherein the sheet has a sinusoidal form extending along the length of the sheet.

17. The vehicle as set forth in claim 16, wherein the carrier includes a planar surface extending along the length of the sheet and interposed between the sheet and at least one of the inner rocker and the outer rocker.

18. The vehicle as set forth in claim 16, wherein a thickness of the sheet of material varies.

19. The vehicle as set forth in claim 16, wherein the sheet includes a plurality of arcuate sections along the sinusoidal form and a number of arcuate sections in a load portion is greater than the number of arcuate sections in a non-load portion.

20. The vehicle as set forth in claim 16, wherein the sheet is a first sheet of material and a second sheet of material, the first sheet of material joined to the second sheet of material to form a plurality of tubes interconnected to each other by a neck portion.
